(19) United States
(12) Patent Application Publication
(10) Pub. No.: US 2015/0285291 A1
(43) Pub. Date: Oct. 8, 2015

(54) Nut

(71) Applicant: VEGA GRIESHABER KG, Wolfach (DE)

(72) Inventor: Thomas Kopp, Wolfach (DE)

(21) Appl. No.: 14/526,752

(22) Filed: Oct. 29, 2014

(30) Foreign Application Priority Data
Dec. 19, 2013 (DE) 10 2013 226 768.1

(51) Int. Cl. F16B 37/00; F16B 35/00

(52) U.S. Cl. CPC F16B 37/00; F16B 35/00

(57) ABSTRACT

A nut (1) having an internal thread (2), an external contour, with a design that is suitable for transmitting a tightening torque to the nut (1) and at least one first surface area (7) essentially oriented in the axial direction (A) of the nut (1), wherein the first surface area (7) comprises at least one cutting mold (5).

The present invention relates to a nut in accordance with the preamble to patent claim 1 as well as a screw in accordance with patent claim 14.

A series of nuts are known from the prior art, commonly comprising an internal thread that can be screwed onto an external thread of a screw having a corresponding design or onto a threaded bolt. Said types of nuts are used for example as nuts for fastening screwed cable connections in ducts of sheet metal casings. The walls of said types of sheet metal casings are generally so thin that they are unable to accommodate screw threads and said types of screwed connections are therefore required for the attachment.

Furthermore, said types of sheet metal casings can typically comprise an insulating surface coating to protect the entire casing against corrosion. If correspondingly coated sheet metal casings having said types of screwed connections are used in media with electrolytic action, it is possible that the effect occurs between metal parts with different electric potential in which the less precious of the two metal parts acts as sacrificial anode and corrodes analogously.

To prevent corrosion involving the corresponding screwed connections, it is necessary to create a conductive connection between the components of the screwed connection and the coated sheet metal casing. In the prior art, a known approach in this regard is to destroy the coating of the sheet metal casing in the area of the screwed connection by means of a screw driver or a different tool with sharp edges and to promote an electrically conductive connection and hence a potential equalization in this fashion. With this approach, it is disadvantageous that an electrically conductive connection may or may not be created, depending on how carefully the coating is removed, such that it is often impossible to create an electrically conductive connection even though the coating has partially been removed. Furthermore, it is considered disadvantageous that a manual intervention is required for every single screwed connection.

One example of said type of screwed connection is illustrated in FIG. 5.

An exemplary screwed connection of said type is illustrated in greater detail in FIG. 5. In this regard, FIG. 5 shows a steel sheet 21 with surface coating 22, said steel sheet having an integrated opening 23. A screw 18 is arranged in the opening 23, wherein a screw head 19 of the screw 18 is arranged on one side of the steel sheet 21 and a screw thread 20 of the screw 18 protrudes through the opening 23 in the steel sheet 21. A nut 1 is screwed onto the screw thread 20 on a side of the steel sheet 21 opposite of the screw head 19.

To create an electrically conductive connection between the nut 1 and the steel sheet 21 and hence to prevent the effect of a sacrificial anode in environments with galvanic action, in which the less precious of two metals with a potential difference present between them is removed within the meaning of a sacrificial anode, the surface coating 22 of the steel sheet 21 is destroyed in the prior art for example by means of a screw driver.

The object of the present invention is to prevent a manual interference for the creation of said type of electrical connection and to create a potential equalization with high security.

This object is solved with a nut having the characteristics of patent claim 1 as well as a screw having the characteristics of patent claim 14.

Advantageous upgrades are described in the dependent claims.

A nut according to the invention traditionally comprises an internal thread and an external contour with a design that is suitable for transmitting a tightening torque to the nut, wherein the nut comprises at least one first surface area essentially oriented in the axial direction of the nut, with at least one cutting mold arranged on it.

By providing a cutting mold on a surface oriented in the axial direction of the nut, it can be achieved that the screw-in motion associated with the tightening of the nut automatically results in the destruction of a surface coating for example of a sheet metal casing that is present near the cutting mold, thus creating an electrically conductive connection between the nut and the sheet metal casing in a reliable fashion. Moreover, a screw or threaded bolt connected with the nut is likewise connected with the sheet metal casing in an electrically conductive fashion, such that a potential equalization likewise takes place here and corrosion due to the effect of a sacrificial anode can hence be prevented.

A plurality of cutting molds are preferably provided on the first surface area of the nut, such that an electrically conductive connection and hence a potential equalization is created in a plurality of areas and hence with greater reliability.

In so doing, the plurality of cutting molds can preferably be arranged regularly distributed on the first surface area, wherein it is advantageous from a manufacturing point of view, if the regular arrangement is provided on a circular curve running around a longitudinal axis of the nut.

In so doing, the first surface area preferably has a ring-shaped design and preferably runs essentially perpendicular to the longitudinal axis of the nut, such that the cutting molds are arranged on a surface that is essentially parallel to a surface area, for example of a sheet metal casing, when the screw connection is established.

In so doing, the cutting edge of the cutting molds are preferably provided in front in the tightening direction of the nut.

In the present application, the tightening direction is deemed to be the screw-in direction in which the nut is screwed onto the screw assigned to it or the threaded bolt assigned to it and tightened with a tightening torque.

The fact that the cutting molds are arranged in front in the tightening direction ensures that a reliable destruction of the surface coating, for example of a sheet metal casing, is achieved when the screw connection is established and the effects mentioned above can hence be achieved with greater security.

A favorable design of the cutting molds is achieved if they comprise an essentially triangular or prism-shaped contour with a pitch with a first angle α of preferably 3 to 10° relative to the first surface area.

Said pitch has the effect that the cutting molds have a greater height at an end positioned in front in the tightening direction than at the end positioned at the back in the tightening direction.

Moreover, the cutting molds can have a pitch in radial direction relative to the first surface area. Said pitch in radial direction can preferably have a negative design, such that the cutting molds become lower as the radius increases. A particularly effective cutting effect can be achieved in this fashion with the corner of the cutting edge positioned in front and on the inside in the tightening direction.

In a top view, the cutting molds can have an essentially annular segment-shaped, rectangular or triangular contour, wherein an annular segment-shaped contour is particularly easy to create, for example with a milling process.

In an upgrade, the cutting edge comprises a second angle of preferably 5° to 30°, more preferably 15° to 20° relative to the radial direction opposite to the tightening direction. The corresponding pitch of the cutting edge relative to the radial direction achieves that removed coating material is transported outward in the radial direction and does not get jammed between the nut and the casing.

In a further embodiment, the cutting edge has a concave course, by way of which a similar transport effect for removed coating material can be achieved.

In addition or alternatively, a face positioned in front in the tightening direction is tipped relative to the radial direction, as a result of which the cutting edge is sharper on the one hand and a better transport away of removed material can be achieved on the other hand.

To prevent the inappropriate use of the nut according to the invention, cutting molds according to the invention can likewise be provided on a second surface area arranged on the opposite side of the first surface area, said second surface area being oriented parallel to the first surface area. If the nut is used, this helps achieve that it is not necessary to pay attention in which orientation it is being used.

The embodiments and upgrades according to the invention described above with regard to a nut can easily be transferred to a screw or a screw head, such that a screw with a correspondingly designed screw head is likewise considered to be in accordance with the invention.

In the following, the present invention is explained in greater detail with reference to the attached figures.

In the figures:

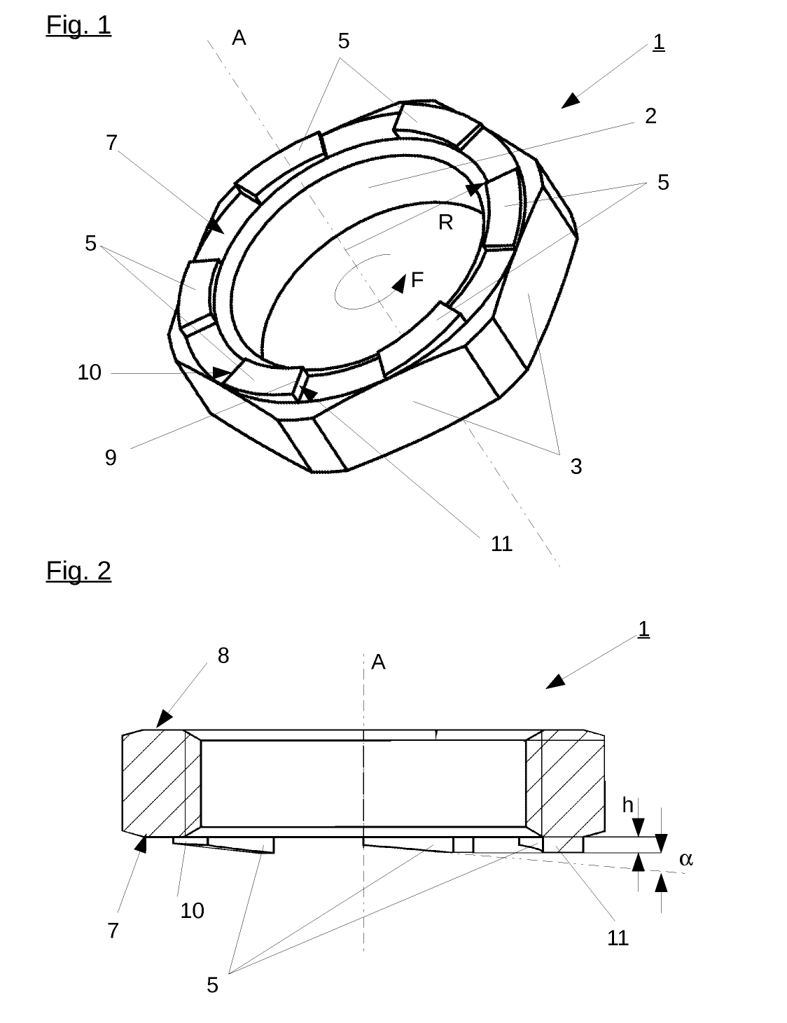

FIG. 1 shows a perspective representation of a nut with cutting molds,

FIG. 2 shows a sectional view through the nut in FIG. 1,

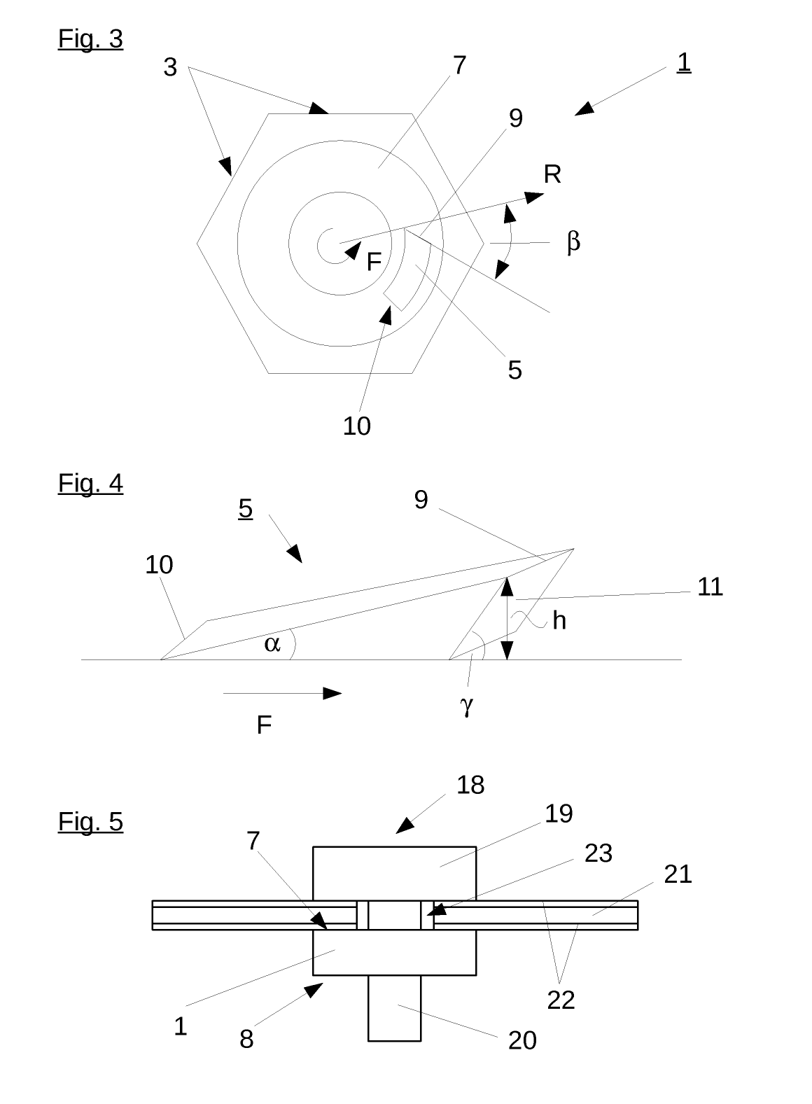

FIG. 3 shows a simplified representation of a top view in axial direction to a further exemplary embodiment of a nut,

FIG. 4 shows an exemplary cutting mold similar to the one used for a nut according to FIG. 3, and

FIG. 5 shows a screwed connection of sheet steel, for which the nuts in the FIGS. 1 to 3 are typically used.

FIG. 1 shows a perspective representation of an exemplary embodiment of a nut 1 according to the present application.

The nut 1 in the present exemplary embodiment comprises an internal thread 2, which has a design that is suitable for being screwed onto a screw or a threaded bolt. Moreover, the nut 1 comprises an external contour 3, designed as a hexagonal external profile in the present exemplary embodiment. However, other external contours, for instance square or star-shaped external contours 3, are conceivable as well, which are selected by the person skilled in the art in accordance with the intended use of the nut 1. With regard to the external contour 3, it is essential that its design is suitable for transmitting a tightening torque to the nut 1, such that it can be attached with the required tightening force when the screwed connection is drawn up.

Furthermore, the nut 1 comprises a first surface area 7 oriented in the axial direction A of the nut 1, said first surface area having a ring-shaped design in the present exemplary embodiment. Six cutting molds 5 are arranged on the first surface area 7.

The present nut 1 is preferably used for screw connections on sheet metal casings, in which an electrically conductive connection is to be achieved between the nut 1 and a sheet steel 21 of the sheet metal casing to create a potential equalization as it is described in FIG. 5.

With a nut as illustrated for example in FIG. 1, a manual interference can be prevented and a potential equalization achieved with high security between the nut 1 and the sheet steel 21.

For this purpose, the nut according to FIG. 1 comprises the cutting molds 5, which comprise a cutting edge 9 in front in the tightening direction F of the nut 1, said cutting edge being designed such that the coating 22 of the sheet steel 21 is destroyed reliably and a conductive metal-on-metal contact is hence reliably created. In the present application, the tightening direction F shall be the screw direction of the nut 1, in which a screw connection is closed and a tightening torque established.

For the nut 1 illustrated in FIG. 1, the cutting molds 5 essentially have an annular segment shape and are distributed regularly. In so doing, the cutting molds 5 in each case sweep across an angle of 30°, wherein the spaces or distances arranged between the cutting molds 5 in each case likewise represent an angular segment of 30° in accordance with the regular arrangement.

As clearly shown in FIG. 1, the cutting edge 9 is oriented in the radial direction, wherein a surface of the cutting mold 5 positioned in front in the tightening direction forms a face 11, on which a potentially created chip from the surface coating is transported away.

The cutting molds 5 according to the exemplary embodiment in FIG. 1 comprise a back edge 10, which is likewise oriented in the radial direction in the present exemplary embodiment.

FIG. 2 shows a sectional view through the nut 1 in FIG. 1, wherein the cutting molds 5 are arranged facing downward in the illustration in FIG. 2.

FIG. 2 illustrates particularly clearly that the cutting molds 5 in a side view have an essentially trapezoid contour, wherein a front edge of the contour and a back edge 10 of the contour run in the axial direction A of the nut 1. In the present exemplary embodiment, the cutting molds 5 are designed with a height h near the cutting edge 9, wherein the height h of the cutting molds 5 decreases toward the back edge 10. All in all, the cutting molds 5 hence have a pitch with a first angle α of approximately 5°. Both the first angle α of the pitch as well as the height h of the cutting molds can vary depending on the use case, which is dependent in particular on a thickness of the surface coating 22 of the sheet steel 21 to be destroyed and penetrated.

Moreover, a second surface area 8 arranged opposite the first surface area 7 and oriented parallel to the first surface area 7 is illustrated in FIG. 2, said second surface area not comprising any cutting molds 5 in the present exemplary embodiment. To enable the use of the present nut 1 in both orientations, cutting molds 5 can likewise be provided on the second surface area 8.

FIG. 3 shows a simplified top view of another exemplary embodiment of a nut 1. The external contour 3 of the nut 1 in FIG. 3 is likewise designed as a hexagonal profile. As it was the case in FIGS. 1 and 2, the first surface 7 is designed as a ring area and only carries one cutting mold 5 in the simplified exemplary embodiment shown in FIG. 3, said cutting mold essentially having the shape of an annular segment in the top view. In contrast to the cutting molds 5 shown in FIGS. 1 and 2, in which the cutting edge 9 runs in the radial direction R, the cutting edge 9 in the exemplary embodiment according to FIG. 3 comprises a second angle β relative to the radial direction R and opposite to the tightening direction F. The second angle β achieves that a chip of the surface coating 22 is transported outward when the nut 1 is tightened and does not get jammed in front of the cutting edge 9 between the first surface area 7 and the sheet steel 21. This helps achieve an electrically conductive connection with even greater security, as the jamming of insulating chips between the nut 1 and the sheet steel 21 is prevented.

In the exemplary embodiment illustrated in FIG. 3, the back edge 10 of the cutting mold 5 runs in the radial direction.

The cutting mold 5 from FIG. 3 is illustrated in a simplified version in FIG. 4, wherein the circular arc-shaped course of the cutting mold is not illustrated for the sake of convenience.

In a side view, the cutting mold 5 according to FIG. 4 comprises a triangular contour, wherein the cutting mold 5 comprises a pitch with a first angle α.

In the cutting mold 5 illustrated in FIG. 4, the face 11 is tipped relative to the radial direction R, such that the transporting away of a chip of a surface coating 22 to be removed is improved considerably.

In the exemplary embodiment illustrated in FIG. 4, the face 11 with the first surface area 7 additionally encloses a third angle γ smaller than 90°, which makes it possible that the cutting edge 9 can be designed with a more acute angle and hence sharper. Moreover, with the third angle γ, it can e. g. be achieved that a potentially created chip of a surface coating 22 comes to rest near the base of the cutting mold 5, thus likewise preventing it from unfolding an insulating effect, even if it is not transported away.

The example of application for the present nuts 1 from FIG. 5 was already explained in greater detail in connection with FIG. 1. At this point, we would like to emphasize that the screw head 19 of the screw 18 can likewise be designed with corresponding cutting molds, such that a conductive connection and hence a potential equalization can also be created between the screw 18 and the sheet steel 21.

### LIST OF REFERENCE CHARACTERS

1 Nut
2 Internal thread
3 External contour
5 Cutting mold
7 First surface area
8 Second surface area
9 Cutting edge
10 Back edge
11 Face
18 Screw
19 Screw head
20 Screw thread
21 Sheet steel
22 Coating
A Axial direction
L Longitudinal direction
R Radial direction
α First angle
β Second angle
T Tightening direction

1. A nut (1) having an internal thread (2), an external contour with a design that is suitable for transmitting a tightening torque to the nut (1) and at least one first surface area (7) essentially oriented in the axial direction (A) of the nut (1), characterized in that the first surface area (7) comprises at least one cutting mold (5).

2. A nut (1) according to claim 1, characterized in that the first surface area (7) comprises a plurality of cutting molds (5).

3. A nut (1) according to claim 2, characterized in that the cutting edges (5) are arranged regularly distributed on the first surface area (7).

4. A nut (1) according to claim 3, characterized in that the cutting molds (5) are arranged on a circular curve running around a longitudinal axis (L) of the nut (1).

5. A nut (1) according to any of the preceding claims, characterized in that the first surface area (7) has a ring-shaped design and is preferably oriented essentially perpendicular to the longitudinal axis (L) of the nut (1).

6. A nut (1) according to any of the preceding claims, characterized in that the cutting molds (5) comprise a cutting edge (9) positioned in front in the tightening direction (F) of the nut (1).

7. A nut (1) according to any of the preceding claims, characterized in that the cutting molds (5) comprise an essentially triangular or prism-shaped contour with a pitch with a first angle (α) of preferably 3° to 20° relative to the first surface area (7) in the side view in the direction of the circumference.

8. A nut (1) according to any of the preceding claims, characterized in that the cutting molds (5) comprise a pitch relative to the first surface area (7) in the radial direction (R).

9. A nut (1) according to any of the preceding claims, characterized in that the cutting molds (5) comprise an essentially annular segment-shaped, rectangular or triangular contour in the top view.

10. A nut (1) according to any of the preceding claims, characterized in that the cutting edge (9) comprises a second angle (β) of at least 10°, preferably at least 20°, most preferably at least 30° relative to the radial direction (R) opposite to the tightening direction (F).

11. A nut (1) according to any of the claims 1 to 9, characterized in that the cutting edge (9) comprises a concave course.

12. A nut (1) according to any of the preceding claims, characterized in that the cutting molds (5) comprise a face (11) in front in the tightening direction (F), said face being tipped relative to the radial direction (R).

13. A nut (1) according to any of the preceding claims, characterized in that the nut (1) comprises a second surface area (8) arranged opposite of the first surface area (7), said second surface area being oriented parallel to the first surface area (7) and designed according to any of the preceding claims.

14. A screw having a screw head (19), designed according to any of the preceding claims.
